(19) United States
(12) Patent Application Publication
(10) Pub. No.: US 2024/0354787 A1
(43) Pub. Date: Oct. 24, 2024

(54) PREDICTION METHOD FOR FORMATION WATER YIELD OF CARBONATE GAS RESERVO

(71) Applicant: SouthWest Petroleum University, Chengdu (CN)

(72) Inventors: Xiong Ding, Chengdu (CN); Yi Song, Chengdu (CN); Benjian Zhang, Chengdu (CN); Xiran Yang, Chengdu (CN); Xinyang He, Chengdu (CN); Xinzhe Zhang, Chengdu (CN); Zhiqiang Yun, Chengdu (CN); Zhongfan Xu, Chengdu (CN)

(21) Appl. No.: 18/527,389

(22) Filed: Dec. 4, 2023

(30) Foreign Application Priority Data
Apr. 23, 2023 (CN) 2023104415012

(51) Int. Cl. G06Q 30/0202; G06Q 50/06

(52) U.S. Cl. CPC G06Q 30/0202; G06Q 50/06

(57) ABSTRACT

A prediction method for formation water yield of carbonate gas reservoir is provided, which includes: S1, constructing an initial prediction model for a formation water yield of a carbonate gas reservoir; S2, collecting and pre-processing raw data; where the raw data is raw data of parameters of the initial prediction model, and the raw data further includes raw data of a permeability when the initial prediction model does not involve permeability; S3, performing, according to the pre-processed raw data, an uncertainty analysis and a dimension reduction process on the parameters of the initial prediction model; S4, constructing a target prediction model for the formation water yield of the carbonate gas reservoir according to a result of dimension reduction process; and S5, obtaining, according to the target prediction model for formation water yield of carbonate reservoir, a predictive probability solution of formation water yield by combining a result of uncertainty analysis.

### TECHNICAL FIELD

The disclosure relates to the field of exploration and development technologies of carbonate gas reservoirs, and more particularly to a prediction method for formation water yield of a carbonate gas reservoir.

### BACKGROUND

Carbonate rocks play an extremely important role in natural gas production in Sichuan Basin, a resource quantity of series of carbonate rock strata accounts for 85 percent (%) of total conventional gas resources in the Sichuan Basin, and proven reserves of the resource quantity of the carbonate rock series account for 70%, which is a main series of strata for achieving natural gas exploration and development benefits in the Sichuan Basin. With more than 60 years of continuous exploration, multiple large and medium-sized gas fields are successively obtained in the series carbonate rock of strata such as middle permian in the southern Sichuan Basin, weiyuan sinian system in the southern Sichuan Basin, carboniferous in the eastern steep structural belt of the Sichuan Basin, and permian and triassic reef shoals in the northern Sichuan Basin.

Formation water yield is one of the most important parameters for understanding production dynamics of oil and gas fields, accurate measurement of the formation water yield is of great significance to a formulation of drainage, water plugging, water blocking and water control countermeasures in a middle and late stage of gas reservoir development. Therefore, accurate prediction of the formation water yield of a carbonate gas reservoir can effectively guide oil and gas field companies in an extraction of the carbonate gas reservoir.

At present, prediction methods for the formation water yield of the carbonate gas reservoir include an ultrasonic method, a capacitance method, a microwave method, a numerical simulation method and the like. However, these methods need many parameters, and obtained raw data by these methods may exist suspicious data, and prediction results have errors. In addition, a prediction value of the formation water yield obtained by the existing methods is a definite value, which does not take into account geological risks of parameters and uncertainty caused by data abundance.

### SUMMARY

Aiming at the above problems, the disclosure aims to provide a prediction method for formation water yield of carbonate gas reservoir.

Technical solutions of the disclosure are as follows.

A prediction method for formation water yield of carbonate gas reservoir is provided, and the prediction method includes:
S1, constructing an initial prediction model for a formation water yield of a carbonate gas reservoir;
S2, collecting raw data, and pre-processing the raw data to obtain pre-processed raw data; wherein the raw data are raw data of parameters of the initial prediction model, and the raw data further comprises raw data of a permeability when the initial prediction model does not involve the permeability;
S3, performing, according to the pre-processed raw data, an uncertainty analysis and a dimension reduction process on the parameters of the initial prediction model to obtain a result of uncertainty analysis and a result of dimension reduction process;
S4, constructing a target prediction model for the formation water yield of the carbonate gas reservoir according to the result of dimension reduction process; and
S5, obtaining, according to the target prediction model for the formation water yield of the carbonate reservoir, a predictive probability solution of the formation water yield of the carbonate gas reservoir by combining the result of uncertainty analysis.

In an exemplary embodiment, the prediction method for formation water yield of carbonate gas reservoir further includes: applying the predictive probability solution in formulating countermeasures of developing the carbonate gas reservoir, and guiding an oil and gas field company in an extraction of the carbonate gas reservoir.

In an embodiment, in step S3, the performing an uncertainty analysis on the parameters of the initial prediction model includes:
S31, selecting a random variable parameter of the parameters of the initial prediction model to perform the uncertainty analysis on the random variable parameter;
S32, constructing a mathematical distribution model for the random variable parameters; wherein the mathematical distribution model is expressed as follows:

$$P ( v ) = ( \frac{1}{\sqrt{2 {πσ}^{2}}} ) {e}^{- \frac{{( v - μ )}^{2}}{2 {σ}^{2}}} , - ∞ < v < ∞ \qquad ( 1 )$$

$$σ = \sqrt{( \sum {v}_{i} - μ ) / n} \qquad ( 2 )$$

$$μ = \sum {v}_{i} / n \qquad ( 3 )$$

wherein P(v) represents a distribution function; o represents a standard deviation; v represents a value of the random variable parameter; u represents a mathematic expectation; vi represents an i-th value of the random variable parameter; and n represents a total number of raw data of the random variable parameter;
S33, performing, according to the mathematical distribution model, a random sampling on the random variable parameter to obtain sampled values, and converting the sampled values to a probability distribution of the random variable parameter through a mathematical formula; wherein the mathematical formula is expressed as follows:

$$F ( v ) = 1 - ( \frac{1}{\sqrt{2 {πσ}^{2}}} ) \int {e}^{[ - \frac{{( v - μ )}^{2}}{2 {σ}^{2}} ]} dv , - ∞ < v < ∞ \qquad ( 4 )$$

wherein F(v) represents a probability distribution function; and
S34, obtaining a probability distribution sampling value of the random variable parameter according to the probability distribution; wherein the probability distribution sampling value is the result of uncertainty analysis of the random variable parameter.

In an embodiment, in step S3, the performing a dimension reduction process on the parameters of the initial prediction model includes:
S31′, standardizing the raw data to obtain standardized data matrix;
S32′, obtaining, according to the standardized data matrix, correlation coefficients, to thereby obtain a correlation coefficient matrix; wherein a formula for calculating each of correlation coefficients is expressed as follows:

$${R}_{ij} = \frac{{\sum }_{k = 1}^{m} ( {x}_{ik} - \overline{{x}_{i}} ) ( {x}_{jk} - \overline{{x}_{j}} )}{\sqrt{{\sum }_{k = 1}^{m}} {( {x}_{ik} - \overline{{x}_{i}} )}^{2} {\sum }_{k = 1}^{m} {( {x}_{jk} - \overline{{x}_{j}} )}^{2}} ( i , j = 1 , 2 , … , n ) \qquad ( 5 )$$

wherein Rᵢⱼ represents the correlation coefficient; m represents a total number of rows or columns of the standardized data matrix; k represents a k-th row or a k-th column; xᵢₖ represents a parameter of an i-th row and a k-th column in the standardized data matrix; \hat{x}ₗ represents an average value of all parameters in the i-th row of the standardized data matrix; xⱼₖ represents a parameter of a j-th column and a k-th row in the standardized data matrix; and x̅ⱼ represents an average value of all parameters in the j-th column of the standardized data matrix;
S33′, constructing an eigenmatrix |R−λE|=0; wherein R represents the correlation coefficient matrix, and E represents an identity matrix;
S34′, solving eigenvalues A of the eigenmatrix, and taking a sum of eigenvalues larger than a total eigenvalue threshold as reduced dimensionality eigenvalues;
S35′, constructing, according to the reduced dimensionality eigenvalues, an equation system (R−λE)X=0, and obtaining nonzero solutions of the equation system; and
S36′, taking the nonzero solutions as eigenvectors corresponding to the reduced dimensionality eigenvalues to obtain a reduced dimensionality parameter as the result of dimension reduction process.

In an embodiment, in step S2, the pre-processing the raw data further includes: eliminating an outlier in raw data of each parameter of the parameters.

In an embodiment, the eliminating an outlier in raw data of each parameter of the parameters includes:
S21, obtaining an average value of the raw data of each parameter, and a deviation D between each raw datum of the raw data of each parameter and the average value;
S22, calculating a probability error p of each parameter according to the deviation D;
S23, constructing a D/p standard value of each parameter, and calculating a D/p value of each raw datum of the raw data of each parameter; and
S24, determining whether each raw datum of the raw data of each parameter is an outlier according to the D/p value and the D/p standard value, comprising:
   in response to the D/p value of a corresponding one raw data being larger than the D/p standard value of the corresponding one raw data, determining the corresponding one raw data as an outlier, and eliminating the corresponding one raw data; in response to the D/p value of a corresponding one raw data being not larger than the D/p standard value of the corresponding one raw data, reserving the corresponding one raw data.

In an embodiment, in step S22, a formula for calculating the probability error p is expressed as follows:

$$p = 0.6745 \sqrt{\frac{{\sum }_{i = 1}^{n} {D}^{2}}{n - 1}} \qquad ( 6 )$$

in step S23, D/p standard values corresponding to different total numbers n of raw data are respectively as follows:
when 5≤n<10 is satisfied, the D/p standard value is 2.5;
when 10≤n<15 is satisfied, the D/p standard value is 2.9;
when 15≤n<20 is satisfied, the D/p standard value is 3.2;
when 20≤n<50 is satisfied, the D/p standard value is 3.3;
when 50≤n<100 is satisfied, the D/p standard value is 3.8; or
when n≥100 is satisfied, the D/p standard value is 4.2.

In an embodiment, in step S1, the initial prediction model is expressed as follows:

$${Q}_{0} = 0.01 Ah φ {S}_{w} / {B}_{w} \qquad ( 7 )$$

where Q₀ represents an initial prediction value of the formation water yield of the carbonate gas reservoir with a unit of 10⁴ cubic meters (m³); A represents a distribution area of formation water with a unit of square kilometer (km²); h represents an average thickness of the carbonate gas reservoir with a unit of meter (m); φ represents a porosity with a unit of percent (%); S_{w} represents a water saturation with a unit of %; and B_{w} represents a volume coefficient of formation water with dimensionless.

In an embodiment, in step S2, the raw data includes a thickness of the carbonate gas reservoir, the porosity, the permeability and the water saturation.

In an embodiment, in step S3, the dimension reduction process is performed on the parameters of the initial prediction model to obtain a first reduced dimensionality parameter and a second reduced dimensionality parameter, the first reduced dimensionality parameter and the second reduced dimensionality parameter are respectively represented as F₁ and F₂, and F₁ is a reduced dimensionality parameter with a highest proportion of eigenvalues in total eigenvalues;
in step S4, the constructing a target prediction model for the formation water yield of the carbonate gas reservoir includes:
S41, fitting a parameter Ah₀F₁ with an actual value of the formation water yield of the carbonate gas reservoir to obtain first fitting coefficients; wherein a mathematical formula (8) for fitting is expressed as follows:

$$Q = {aAh}_{0} {F}_{1}^{2} + {bAh}_{0} {F}_{1} + c \qquad ( 8 )$$

wherein Q represents the actual value of the formation water yield of the carbonate gas reservoir with a unit of 10⁴ m³; a, b, and c represent the first fitting coefficients; and h₀ represents an average sampling thickness of the carbonate gas reservoir with a unit of m;
S42, fitting F₁ with F₂ to obtain second fitting coefficients; wherein mathematical formulas (9)-(11) for fitting are expressed as follows:

$$y = d + ex \qquad ( 9 )$$

$$d = \overline{y} - e \overline{x} \qquad ( 10 )$$

$$e = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 11 )$$

wherein e and d represent the second fitting coefficients; xᵢ represents an i-th independent variable parameter; x̅ represents an average value of independent variable parameters; yᵢ represents an i-th dependent variable parameter; y represents an average value of dependent variable parameters; and
S43, substituting the first fitting coefficients obtained in step S41 and the second fitting coefficients obtained in step S42 into the mathematical formula (8), to obtain a first prediction model for the formation water yield of the carbonate gas reservoir by a formula (12) as follows:

$${Q}_{1} = {Ah}_{0} ( {aF}_{1}^{2} + {beF}_{2} ) + c + bd \qquad ( 12 )$$

wherein Q₁ represents a first prediction value of the formation water yield of the carbonate gas reservoir with a unit of 10⁴ m³.

In an embodiment, in step S4, the constructing a target prediction model for the formation water yield of the carbonate gas reservoir further includes:
S44, fitting, through the mathematical formula (9), the first prediction value of the formation water yield of the carbonate gas reservoir obtained by the formula (12) with the actual value of the formation water yield of the carbonate gas reservoir to obtain third fitting coefficients;
S45, substituting the third fitting coefficients into the formula (8) to obtain the target prediction model for the formation water yield of the carbonate gas reservoir as follows:

$${Q}_{2} = {e}_{1} {Ah}_{0} ( {aF}_{1}^{2} + {beF}_{2} ) + {e}_{1} c + {e}_{1} bd + {d}_{1} \qquad ( 13 )$$

wherein Q₂ represents a target prediction value of the formation water yield of the carbonate gas reservoir with a unit of 10⁴ m³; and e₁ and d₁ represent the third fitting coefficients. Beneficial effects of the disclosure are as follows.

The dimension reduction process in the disclosure is used to simplify the initial prediction model, reduce an error of a prediction result for the formation water yield of the carbonate gas reservoir, and improve predictive accuracy of the initial prediction model, an uncertainty of prediction for the formation water yield of the carbonate gas reservoir is analyzed by performing the uncertainty analysis on the parameters of the initial prediction model to obtain the predictive probability solution for the formation water yield of the carbonate gas reservoir, so as to solve technical problems of obtaining too many parameters, inaccurate parameter acquisition, and failure to consider geological risks of each parameter and uncertainty caused by data abundance in existing prediction methods for the formation water yield of the carbonate gas reservoir.

### BRIEF DESCRIPTION OF DRAWINGS

In order to provide a clearer description of technical solutions in embodiments of the disclosure or related art, drawings required in the embodiments or the related art descriptions will be introduced below. Apparently, the drawings described below are merely some of the embodiments of the disclosure, according to the drawings, other drawings can be obtained by those skilled in the art without creative work.

FIG. 1 illustrates a histogram of sampling values of a parameter h according to an embodiment of the disclosure.

FIG. 2 illustrates a probability distribution diagram of the parameter h according to an embodiment of the disclosure.

FIG. 3 illustrates a relationship diagram between an actual value of formation water yield of a carbonate gas reservoir Q and a parameter Ah₀F₁ according to an embodiment of the disclosure.

FIG. 4 illustrates a relationship diagram between a first reduced dimensionality parameter F₁ and a second reduced dimensionality parameter F₂ according to an embodiment of the disclosure.

FIG. 5 illustrates a comparison diagram of the actual value and a first prediction value of the formation water yield of the carbonate gas reservoir according to an embodiment of the disclosure.

FIG. 6 illustrates a correlation diagram of the actual value and the first prediction value of the formation water yield of the carbonate gas reservoir according to an embodiment of the disclosure.

FIG. 7 illustrates a comparison diagram of the actual value, the first prediction value and a second prediction value (i.e., a target prediction value) of the formation water yield of the carbonate gas reservoir according to an embodiment of the disclosure.

### DETAILED DESCRIPTION OF EMBODIMENTS

The disclosure will be further described in conjunction with drawings and embodiments. It should be noted that in a case of no conflict, the embodiments in the disclosure and technical features in the embodiments can combine with each other. It should be pointed out that unless otherwise specified, all technical and scientific terms used in the disclosure have same meanings as commonly understood by those skilled in the art to which the disclosure belongs. Terms “including” or “containing” used in the disclosure mean that the elements or objects appearing before the word cover the elements or objects listed after the word and their equivalents, without excluding other elements or objects.

The disclosure provides a prediction method for formation water yield of carbonate gas reservoir, and the prediction method includes the following steps S1-S5.

In step S1, an initial prediction model for a formation water yield of a carbonate gas reservoir is constructed.

In an embodiment, the initial prediction model is expressed as follows:

$${Q}_{0} = 0.01 Ah φ {S}_{w} / {B}_{w} \qquad ( 7 )$$

where Q₀ represents an initial prediction value of the formation water yield of the carbonate gas reservoir with a unit of 10⁴ cubic meters (m³); A represents a distribution area of formation water with a unit of square kilometer (km²); h represents an average thickness of the carbonate gas reservoir with a unit of meter (m); φ represents a porosity with a unit of percent (%); S_{w} represents a water saturation with a unit of %; and B_{w} represents a volume coefficient of formation water with dimensionless.

It should be noted that there are many existing prediction models for predicting the formation water yield of the carbonate gas reservoir, in addition to the initial prediction model of the above embodiment, other models can adopt the disclosure to improve accuracy of model prediction and obtain a predictive probability solution of the models.

In step S2, raw data is collected, and is pre-processed to obtain pre-processed raw data; and the raw data is raw data of parameters of the initial prediction model, and the raw data further includes raw data of a permeability when the initial prediction model does not involve the permeability.

In an embodiment, the initial prediction model shown in the formula (7) is taken as an example, the raw data needs to be collected includes a thickness of the carbonate gas reservoir, the porosity, the permeability and the water saturation.

In an embodiment, an outlier in the raw data of each parameter of the parameters is eliminated when the raw data is pre-processed. In an embodiment, the outlier in the raw data of each parameter of the parameters is eliminated through the following steps S21-S24.

In step S21, an average value of the raw data of each parameter and a deviation D between each raw datum of the raw data of each parameter and the average value are obtained.

In step S22, a probability error p of each parameter is calculated according to the deviation D; specifically, the probability error p is calculated by the following formula (6):

$$p = 0.6745 \sqrt{\frac{{\sum }_{i = 1}^{n} {D}^{2}}{n - 1}} \qquad ( 6 )$$

where n represents a total number of the raw data of each parameter.

In step S23, a D/p standard value of each parameter is constructed, and a D/p value of each raw datum of the raw data of each parameter is calculated.

When constructing the D/p standard value, an identification standard for the outlier is that in n numbers of the raw data, the deviations D of all raw data are obtained, when a deviation of a corresponding one raw data is D₁, and probability of occurrence of all deviations equal to or greater than D₁ is smaller than 1/(2n), the corresponding one raw data is an outlier, and the corresponding one raw data is eliminated. The D/p standard value corresponding to a number of the raw data n as shown in Table 1 is constructed according to the identification standard.

TABLE 1
D/p standard value

| n | [5, 10) | [10, 15) | [15, 20) | [20, 50) | [50, 100) | [100, ∞) |
|---|---|---|---|---|---|---|
| D/p | 2.5 | 2.9 | 3.2 | 3.3 | 3.8 | 4.2 |

It should be noted that a prediction accuracy is not high because the raw data is too small and less than 5, therefore, n smaller than 5 is not considered here, but the method of obtaining the D/p standard value is consistent.

In step S24, whether each raw datum of the raw data of each parameter is an outlier is determined according to the D/p value and the D/p standard value; in response to the D/p value of a corresponding one raw data is being larger than the D/p standard value of the corresponding one raw data, the corresponding one raw data is an outlier, and the corresponding one raw data is eliminated; in response to the D/p value of a corresponding one raw data being not larger than the D/p standard value of the corresponding one raw data, the corresponding one raw data is reserved.

It should be noted that the method for eliminating the outlier in the above embodiment is merely one eliminating method of the disclosure, a purpose of the method is to improve an accuracy of a prediction result by eliminating suspicious data in the raw data, other methods for eliminating the outlier in the related art can be also applied in the disclosure, for example, in a quartile method, upper and lower thresholds can be directly set, or an error between each value and an average value can be calculated after calculating the average value, an error threshold can be set to determine the outlier.

In step S3, an uncertainty analysis and a dimension reduction process are performed on the parameters of the initial prediction model according to the pre-processed raw data, to obtain a result of uncertainty analysis and a result of dimension reduction process.

In an embodiment, the uncertainty analysis is performed on the parameters of the initial prediction model through the following steps S31-S34.

In step S31, a random variable parameter of the parameters of the initial prediction model is selected to perform the uncertainty analysis on the random variable parameter.

In step S32, a mathematical distribution model is constructed for the random variable parameter, and the mathematical distribution model is expressed as follows:

$$P ( v ) = ( \frac{1}{\sqrt{2 π {σ}^{2}}} ) {e}^{- \frac{{( v - μ )}^{2}}{2 {σ}^{2}}} , \qquad ( 1 )$$

$$- ∞ < v < ∞$$

$$σ = \sqrt{( \sum {v}_{i} - μ ) / n} \qquad ( 2 )$$

$$μ = \sum {v}_{i} / n \qquad ( 3 )$$

where P(v) represents a distribution function; o represents a standard deviation; v represents a value of the random variable parameter; u represents a mathematic expectation; vi represents an i-th value of the random variable parameter.

In step S33, a random sampling is performed on the random variable parameter according to the mathematical distribution model, to obtain sampled values, and the sampled values are converted to a probability distribution of the random variable parameter through a mathematical formula, and the mathematical formula is expressed as follows:

$$F ( v ) = 1 - ( \frac{1}{\sqrt{2 π {σ}^{2}}} ) \int {e}^{[ - \frac{{( v - μ )}^{2}}{2 {σ}^{2}} ]} dv , \qquad ( 4 )$$

$$- ∞ < v < ∞$$

where F(v) represents a probability distribution function.

It should be noted that when performing the random sampling, the more sampling times, the higher accuracy of later prediction results. In an embodiment, at least 6000 random samples are performed when performing the random sampling, so that more stable prediction accuracy is achieved.

In step S34, a probability distribution sampling value of the random variable parameter is obtained according to the probability distribution, and the probability distribution sampling value is the result of uncertainty analysis of the random variable parameter.

In an embodiment, the dimension reduction process is performed on the parameters of the initial prediction model through the following steps S31′-S36′.

In step S31′, the raw data is standardized to obtain standardized data matrix.

In an embodiment, a formula for standardizing is expressed as follows:

$${x}_{ij}^{′} = \frac{{x}_{ij} - {\overline{x}}_{j}}{{max}_{1 \leq i \leq n} {x}_{ij} - {min}_{1 \leq i \leq n} {x}_{ij}} \qquad ( 14 )$$

where x′ᵢⱼ represents a standardized parameter in an i-th row and a j-th column of the standardized data matrix; xᵢⱼ represents a parameter in the i-th row and the j-th column of the standardized data matrix; and x̅ⱼ represents an average of all parameters in the j-th column of the standardized data matrix.

It should be noted that standardization of the raw data is to eliminate effects of variables on levels and dimensions. In addition to the formula for standardizing adopted in the above embodiment, other standardizing method in the related art can be also applied in the disclosure.

In step S32′, correlation coefficients are obtained according to the standardized data matrix, to thereby obtain a correlation coefficient matrix; and a formula for calculating each of the correlation coefficients is expressed as follows:

$${R}_{ij} = \frac{{\sum }_{k = 1}^{m} ( {x}_{ik} - {\overline{x}}_{ι} ) ( {x}_{jk} - \overline{{x}_{J}} )}{{\sqrt{{\sum }_{k = 1}^{m} (} {x}_{ik} - {\overline{x}}_{ι} )}^{2} {\sum }_{k = 1}^{m} {( {x}_{jk} - \overline{{x}_{J}} )}^{2}} ( i , j = 1 , 2 , … , n ) \qquad ( 5 )$$

where Rᵢⱼ represents the correlation coefficient; m represents a total number of rows or columns of the standardized data matrix; k represents a k-th row or a k-th column; xᵢₖ represents a parameter of an i-th row and a k-th column in the standardized data matrix; x̅ₗ represents an average value of all parameters in the i-th row of the standardized data matrix; and xⱼₖ represents a parameter of a j-th column and a k-th row in the standardized data matrix.

In step S33′, an eigenmatrix |R−λE|=0 is constructed; and R represents the correlation coefficient matrix, and E represents an identity matrix.

In step S34′, eigenvalues A of the eigenmatrix are solved, and a sum of eigenvalues larger than a total eigenvalue threshold is taken as reduced dimensionality eigenvalues.

In step S35′, an equation system (R−λE) X=0 is constructed according to the reduced dimensionality eigenvalues, and nonzero solutions of the equation system are obtained.

In step S36′, the nonzero solutions are taken as eigenvectors corresponding to the reduced dimensionality eigenvalues A to obtain a reduced dimensionality parameter, and the reduced dimensionality parameter is the result of dimension reduction process.

In step S4, a target prediction model for the formation water yield of the carbonate gas reservoir is constructed according to the result of the dimension reduction process.

In an embodiment, the initial prediction model shown in the formula (7) is taken as an example, and its corresponding result of dimension reduction process is to obtain two reduced dimensionality parameters, which are respectively F₁ (i.e., first reduced dimensionality parameter) and F₂ (i.e., second reduced dimensionality parameter), and F₁ is a reduced dimensionality parameter with a highest proportion of eigenvalues in total eigenvalues. The target prediction model for the formation water yield of the carbonate gas reservoir is constructed through the following steps S41-S43.

In step S41, a parameter of Ah₀F₁ is fitted with an actual value of the formation water yield of the carbonate gas reservoir to obtain first fitting coefficients; and a mathematical formula (8) for fitting is expressed as follows:

$$Q = {aAh}_{0} {F}_{1}^{2} + {bAh}_{0} {F}_{1} + c \qquad ( 8 )$$

where Q represents the actual value of the formation water yield of the carbonate gas reservoir with a unit of 10⁴ m³; a, b, and c represent the first fitting coefficients; and h₀ represents an average sampling thickness of the carbonate gas reservoir with a unit of m.

In an embodiment, the average sampling thickness of the carbonate gas reservoir is an average value of sampling values with a probability of 100% and a probability of 90% obtained when performing the uncertainty analysis on a parameter h (i.e., the average thickness of the carbonate gas reservoir). It should be noted that, the average sampling thickness of the carbonate gas reservoir can also adopt an average value of sampling values with the probability of 100% and a probability of 95%, it is specifically determined according to the probability selected when performing the uncertainty analysis, moreover, results obtained will be more accurate when selecting an average value of sampling values with a probability of over 90%.

In step S42, F₁ is fitted with F₂ to obtain second fitting coefficients; and mathematical formulas (9)-(11) for fitting are expressed as follows:

$$y = d + ex \qquad ( 9 )$$

$$d = \overline{y} - e \overline{x} \qquad ( 10 )$$

$$e = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 11 )$$

where e and d represent the second fitting coefficients; xᵢ represents an i-th independent variable parameter; x̅ represents an average value of independent variable parameters; yᵢ represents an i-th dependent variable parameter; y̅ represents an average value of dependent variable parameters; and n represents the total number of the raw data of the random variable parameter.

In step S43, the first fitting coefficients obtained in step S41 and the second fitting coefficients obtained in step S42 are substituted into the mathematical formula (8), to obtain a first prediction model for the formation water yield of the carbonate gas reservoir by a formula (12) as follows:

$${Q}_{1} = {Ah}_{0} ( {aF}_{1}^{2} + {beF}_{2} ) + c + bd \qquad ( 12 )$$

where Q₁ represents a first prediction value of the formation water yield of the carbonate gas reservoir with a unit of 10⁴ m³

In an embodiment, in order to improve the accuracy of the first prediction model, the target prediction model for the formation water yield of the carbonate gas reservoir is further constructed through the following steps S44-S45.

In step S44, the first prediction value of the formation water yield of the carbonate gas reservoir obtained by the formula (12) is fitted with the actual value of the formation water yield of the carbonate gas reservoir through the formula (9) to obtain third fitting coefficients.

In step S45, the third fitting coefficients are substituted into the mathematical formula (8) to obtain the target prediction model for the formation water yield of the carbonate gas reservoir as follows:

$${Q}_{2} = {e}_{1} {Ah}_{0} ( {aF}_{1}^{2} + {beF}_{2} ) + {e}_{1} c + {e}_{1} bd + {d}_{1} \qquad ( 13 )$$

where Q₂ represents a target prediction value of the formation water yield of the carbonate gas reservoir with a unit of 10⁴ m³; and e₁ and d₁ represent the third fitting coefficients.

In step S5, a predictive probability solution of the formation water yield of the carbonate gas reservoir is obtained according to the target prediction model for the formation water yield of the carbonate gas reservoir and by combining the result of uncertainty analysis.

In the above embodiments, the first prediction value of the formation water yield of the carbonate gas reservoir is obtained by the first prediction model for the formation water yield of the carbonate gas reservoir through fitting, and a quadratic fitting is performed on the first prediction value of the formation water yield of the carbonate gas reservoir, thus further reducing the error, which can obtain a higher prediction accuracy.

In an embodiment, a carbonate gas reservoir is taken as an example, formation water yield of the carbonate gas reservoir is predicted by the prediction method for formation water yield of carbonate gas reservoir of the disclosure, and the prediction process includes the following steps (1)-(7).

In step (1), the initial prediction model for the formation water yield of the carbonate gas reservoir shown in the formula (7) is constructed, related raw data of the carbonate gas reservoir from 2004 to 2022 is collected, and the related raw data is shown in Table 2 and Table 3.

TABLE 2
Actual values and data of related parameters of the
formation water yield of the carbonate gas reservoir

| | Q (10⁴ m³) | | Permeability (K with a unit of | |
|---|---|---|---|---|
| Year | Actual value | φ (%) | millidarcy abbreviated as mD) | S_{w} (%) |
| 2004 | 31.52 | 18.37 | 68.73 | 21.76 |
| 2005 | 33.07 | 18.99 | 70.02 | 22.34 |
| 2006 | 35.62 | 19.87 | 71.45 | 23.01 |
| 2007 | 39.66 | 21.05 | 73.98 | 23.98 |
| 2008 | 44.67 | 22.45 | 76.92 | 25.24 |
| 2009 | 50.19 | 22.53 | 80.35 | 27.18 |
| 2010 | 57.38 | 22.91 | 84.29 | 29.74 |
| 2011 | 65.78 | 23.56 | 89.74 | 32.81 |
| 2012 | 77.93 | 33.72 | 96.26 | 36.05 |
| 2013 | 90.02 | 25.47 | 103.92 | 39.77 |
| 2014 | 102.37 | 26.31 | 112.35 | 43.21 |
| 2015 | 112.51 | 26.98 | 121.76 | 47.83 |
| 2016 | 120.84 | 28.03 | 127.64 | 50.91 |
| 2017 | 126.12 | 28.45 | 131.82 | 53.12 |
| 2018 | 129.83 | 28.87 | 133.97 | 54.23 |
| 2019 | 128.05 | 27.93 | 133.02 | 53.72 |
| 2020 | 126.23 | 27.17 | 131.87 | 52.97 |
| 2021 | 123.31 | 25.67 | 130.21 | 51.86 |
| 2022 | 119.17 | 23.81 | 127.52 | 50.24 |

TABLE 3
Thicknesses, a distribution area of formation water, and a volume
coefficient of formation water of the carbonate gas reservoir
Thickness h (m) of the carbonate gas reservoir

| | | | |
|---|---|---|---|
| 3.33 | 17.94 | 16.41 | 10.62 |
| 9.81 | 10.94 | 11.71 | 14.21 |
| 16.32 | 11.45 | 13.43 | 7.41 |
| 15.23 | 13.53 | 8.72 | 6.68 |
| 6.83 | 4.89 | 5.13 | 9.44 |
| 6.13 | 9.67 | 11.32 | 9.18 |

| | |
|---|---|
| Distribution area A (km²) of the formation water | 17680 |
| Volume coefficient B_{w} of the formation water | 1.02 |

In step (2), the raw data in Table 2 and Table 3 are pre-processed to obtained pre-processed raw data, and outliers in the raw data are eliminated.

An average value x̅ of each parameter, a deviation D between each raw datum value and the average value, D² and a probability error p (p=0.6745\sqrt{Σᵢ₌₁¹⁹Dᵢ²/18}) are obtained in sequence; a D/p value of a corresponding one raw data is compared to the D/p standard values shown in Table 1 (the number of the corresponding one raw data in the embodiment is n=19, therefore, 3.2 is selected as the D/p standard value of the embodiment), when the D/p value of the corresponding one raw data is larger than the D/p standard value, the corresponding one raw data is an outlier, and the corresponding one raw data is eliminated. Related calculation results of the step are shown in Table 4 and Table 5.

TABLE 4
Related calculation results of the porosity, the permeability and the water saturation

| φ̅ (%) | D | D² | p | K̅ (mD) | D | D² | p | S̅_{w} (%) | D | D² | p |
|---|---|---|---|---|---|---|---|---|---|---|---|
| 24.80 | 6.43 | 41.34 | 2.63 | 103.46 | 34.73 | 1206.47 | 17.25 | 38.95 | 17.19 | 295.35 | 8.55 |
| | 5.81 | 33.76 | | | 33.44 | 1118.52 | | | 16.61 | 275.75 | |
| | 4.93 | 24.30 | | | 32.01 | 1024.91 | | | 15.94 | 253.95 | |
| | 3.75 | 14.06 | | | 29.48 | 869.32 | | | 14.97 | 223.97 | |
| | 2.35 | 5.52 | | | 26.54 | 704.60 | | | 13.71 | 187.85 | |
| | 2.27 | 5.15 | | | 23.11 | 534.27 | | | 11.77 | 138.43 | |
| | 1.89 | 3.57 | | | 19.17 | 367.65 | | | 9.21 | 84.75 | |
| | 1.24 | 1.54 | | | 13.72 | 188.35 | | | 6.14 | 37.65 | |
| | 8.92 | 79.57 | | | 7.20 | 51.90 | | | 2.90 | 8.39 | |
| | 0.67 | 0.45 | | | 0.46 | 0.21 | | | 0.82 | 0.68 | |
| | 1.51 | 2.28 | | | 8.89 | 78.96 | | | 4.26 | 18.18 | |
| | 2.18 | 4.75 | | | 18.30 | 334.74 | | | 8.88 | 78.93 | |
| | 3.23 | 10.43 | | | 24.18 | 584.47 | | | 11.96 | 143.14 | |
| | 3.65 | 13.32 | | | 28.36 | 804.05 | | | 14.17 | 200.91 | |
| | 4.07 | 16.56 | | | 30.51 | 930.60 | | | 15.28 | 233.61 | |
| | 3.13 | 9.80 | | | 29.56 | 873.54 | | | 14.77 | 218.28 | |
| | 2.37 | 5.62 | | | 28.41 | 806.89 | | | 14.02 | 196.68 | |
| | 0.87 | 0.76 | | | 26.75 | 715.34 | | | 12.91 | 166.78 | |
| | 0.99 | 0.98 | | | 24.06 | 578.68 | | | 11.29 | 127.56 | |

TABLE 5
Related calculation results of the thicknesses
of the carbonate gas reservoir

| h (m) | D | D² | D | D² | p |
|---|---|---|---|---|---|
| 10.43 | 7.1 | 50.42 | 5.98 | 35.76 | 4.61 |
| | 0.62 | 0.38 | 1.28 | 1.64 | |
| | 5.89 | 34.69 | 3 | 9 | |
| | 4.8 | 23.04 | 1.71 | 2.93 | |
| | 3.6 | 12.96 | 5.3 | 28.09 | |
| | 4.3 | 18.49 | 0.89 | 0.79 | |
| | 7.51 | 56.39 | 0.19 | 0.04 | |
| | 0.51 | 0.26 | 3.78 | 14.29 | |
| | 1.02 | 1.04 | 3.02 | 9.12 | |
| | 3.1 | 9.61 | 3.75 | 14.07 | |
| | 5.54 | 30.7 | 0.99 | 0.98 | |
| | 0.76 | 0.58 | 1.25 | 1.56 | |

It can be seen from Table 4 and Table 5, parameters K, S_{w} and h are normal, and no suspicious data; when φ=33.72%, D=8.92, and D/p=3.39>3.2, therefore, 33.72% is an outlier, is eliminated, and replaced by an average value of other values.

In step (3), the uncertainty analysis is performed on the parameters of the initial prediction model.

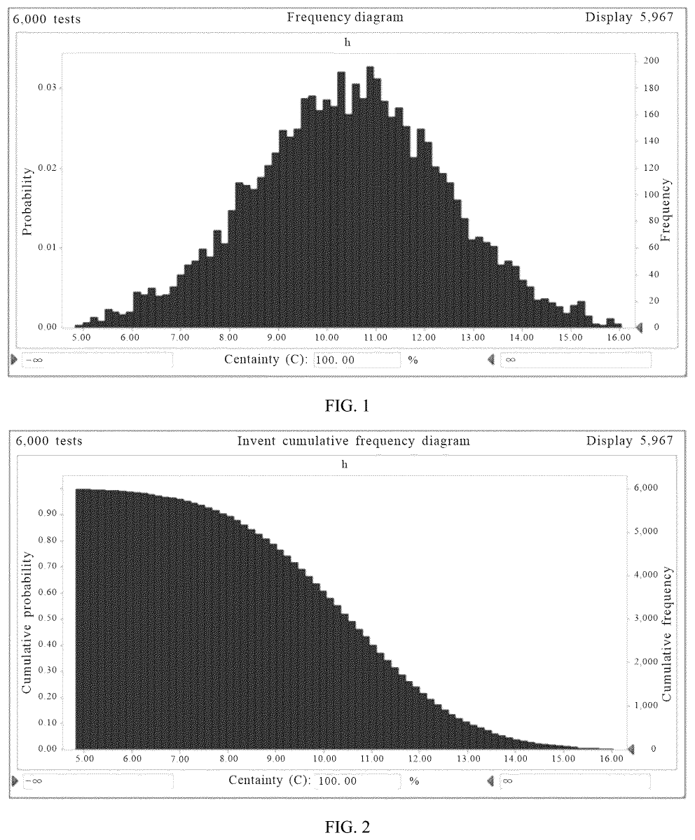

In the initial prediction model shown in the formula (7), h is a random variable with a certain value range, thus h is taken as a random variable parameter to perform the uncertainty analysis, to thereby obtain a probability distribution of sampling values of the random variable parameter h. Specifically, 6000 random samplings are performed through the formulas (1)-(3) to obtain a histogram of a sampling value distribution of the random variable parameter h shown in FIG. 1; and the sampling value distribution is converted to the probability distribution of the random variable parameter h by adopting the mathematical formula shown in the formula (4), to thereby obtain a probability distribution diagram shown in FIG. 2 and a data table of sampling values with a probability of 100%-0% for the random variable parameter h shown in Table 6.

TABLE 6
Data table of sampling values with a probability
of 100%-0% for the random variable parameter h

| Probability | h (m) |
|---|---|
| 100% | 3.33 |
| 90% | 7.86 |
| 80% | 8.75 |
| 70% | 9.35 |
| 60% | 9.91 |
| 50% | 10.42 |
| 40% | 10.94 |
| 30% | 11.48 |
| 20% | 12.14 |
| 10% | 12.98 |
| 0% | 17.94 |

An average value of sampling values with the probability of 100% and the probability of 90% in Table 6 is calculated, the average value is used as the average sampling thickness of the carbonate gas reservoir h₀ in subsequent steps, and a result is h₀=5.595 m.

In step (4), the dimension reduction process is performed on the parameters of the initial prediction model.

The dimension reduction process is performed on the parameters φ, K and S_{w} needed in the initial prediction model; specifically, each value of the parameters is standardized to obtain standardized value, to thereby eliminate effects of the parameter on level and dimension, the correlation coefficient matrix of the standardized data is obtained through the formula (5), and results are shown in Table 7.

TABLE 7
The correlation coefficient matrix of the parameters φ, K and S_{w}

| Parameter | φ | K | S_{w} |
|---|---|---|---|
| φ | 1 | 0.879 | 0.881 |
| K | 0.879 | 1 | 1 |
| S_{w} | 0.881 | 1 | 1 |

The eigenmatrix is constructed and eigenvalues of the eigenmatrix are obtained, and the eigenmatrix is expressed as follows:

$$\vert R - λ E \vert = \begin{matrix}1 - λ & 0.879 & 0.881 \\ 0.879 & 1 - λ & 1 \\ 0.881 & 1 & 1 - λ\end{matrix} \qquad ( 15 )$$

The eigenvalues obtained are respectively as λ₁=2.841, λ₂=0.158, and λ₃=0.0001. From this, it can be calculated that λ₁/Σᵢ₌₁³λᵢ=94.710%, and λ₂/Σᵢ₌₁³λᵢ=5.276%, so that (λ₁+λ₂)/Σᵢ₌₁³λᵢ=99.986%>95%, therefore, first two reduced dimensionality parameters are selected to represents the parameters φ, K and S_{w}.

λ₁ and λ₂ are substituted into the eigenmatrix to construction the equation system as follows:

$$\{ \begin{matrix}( 1 - 2.841 ) {x}_{1} + 0.879 {x}_{2} + 0.881 {x}_{3} = 0 \\ 0.879 {x}_{1} + ( 1 - 2.841 ) {x}_{2} + {x}_{3} = 0 \\ 0.881 {x}_{1} + {x}_{2} + ( 1 - 2.841 ) {x}_{3} = 0\end{matrix} \qquad ( 16 )$$

$$\{ \begin{matrix}( 1 - 0.158 ) {x}_{4} + 0.879 {x}_{5} + 0.881 {x}_{6} = 0 \\ 0.879 {x}_{4} + ( 1 - 0.158 ) {x}_{5} + {x}_{6} = 0 \\ 0.881 {x}_{4} + {x}_{5} + ( 1 - 0.158 ) {x}_{6} = 0\end{matrix} \qquad ( 17 )$$

Eigenvectors are obtained according to the formulas (16) and (17), and the eigenvectors are respectively as x₁=0.332, x₂=0.347, x₃=0.348, x₄=2.082, x₅=−1.008, and x₆=−0.983. From this, the reduced dimensionality parameters are obtained as F₁=0.3324+0.347K+0.348S_{w}, and F₂=2.082φ−1.008 K−0.983S_{w}.

In step (5), a target prediction model for the formation water of the carbonate gas reservoir is constructed according to the result of dimension reduction process in step (4).

The 11 corresponding to the F₁ occupies 94.710% of total eigenvalues, which contains the most raw parameters, and the prediction result will be more accurate, therefore, the parameter Ah₀F₁ is fitted with the actual value of the formation water yield of the carbonate gas reservoir to obtain a relationship diagram between the parameter Ah₀F₁ and the actual value Q, and the relationship diagram is shown in FIG. 3. A multinomial is obtained by combining the mathematical formula (8) and FIG. 3 as follows:

$$Q = - 4.178 E - 12 {Ah}_{0} {F}_{1}^{2} + 7.279 E - 5 {Ah}_{0} {F}_{1} - 112.689 \qquad ( 18 )$$

In the formula (18), the correlation coefficient is 0.9997; a quadratic term coefficient is −4.178E−12, which is a value of the first fitting coefficient a; and a one-order term coefficient is 7.279E−5, which a value of the first fitting coefficient b, and a constant term is −112.689, which is a value of the first fitting coefficient c.

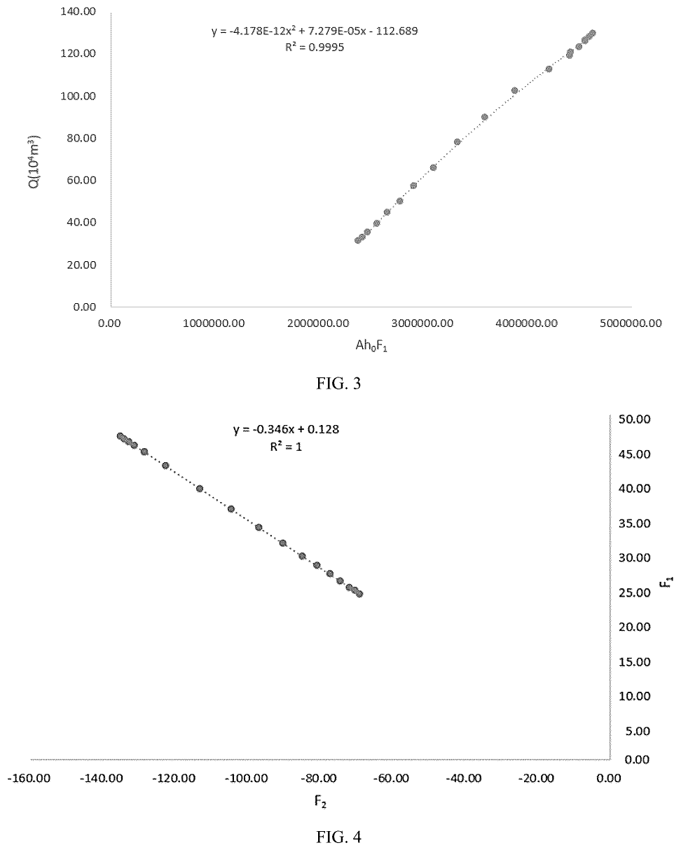

The F₁ is fitted with the F₂ to obtain a relationship diagram between the F₁ and the F₂, and the relationship diagram is shown in FIG. 4, thus obtaining a multinomial as follows:

$$y = - 0.346 x + 0.128 \qquad ( 19 )$$

In the formula (19), the correlation coefficient is 1; a constant term is 0.128, which is a value of the second fitting coefficient d; and a one-order term coefficient is −0.346, which is a value of the second fitting coefficient e.

The above fitting coefficients a, b, c, d and e are substituted into the formula (12) to obtain a first prediction model for the formation water yield of the carbonate gas reservoir (i.e., a first formula) as follows:

$$Q = {Ah}_{0} ( - 4.178 E - 12 {F}_{1}^{2} - 2.519 E - 5 {F}_{2} ) - 112.689 \qquad ( 20 )$$

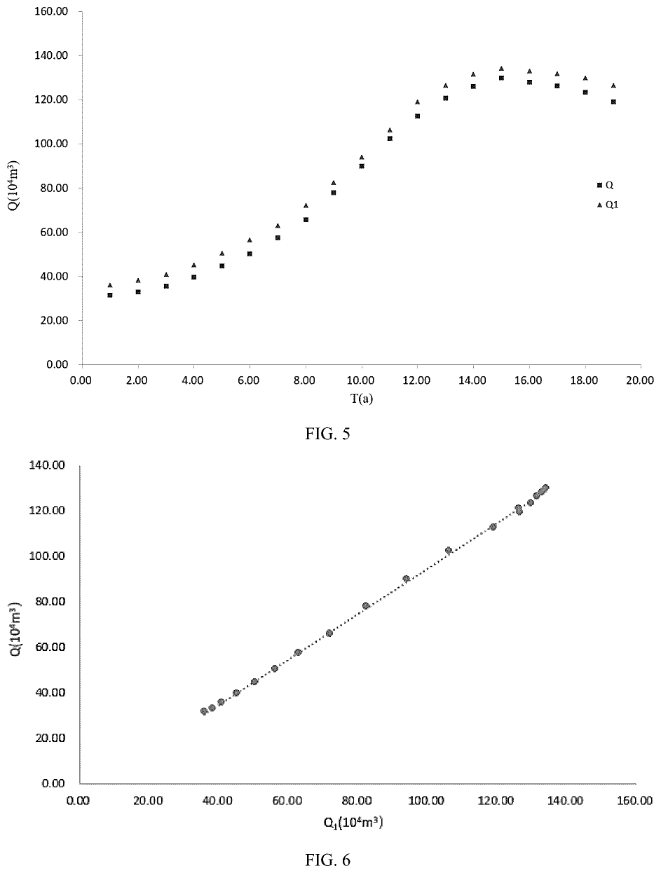

The A, h₀, F₁ and F₂ obtained in the above steps are substituted into the formula (20) to obtain first prediction values of the formation water yield of the carbonate gas reservoir as shown in FIG. 5 and Table 8.

TABLE 8
The actual values, first prediction values and related parameter
data of the formation water yield of the carbonate gas reservoir

| | Q (10⁴ m³) | | | | | | | |
|---|---|---|---|---|---|---|---|---|
| | | First | | | | | | |
| | Actual | prediction | Relative | | | | | |
| Year | value | value | error | φ | K (mD) | S_{w} | F₁ | F₂ |
| 2004 | 31.52 | 35.97 | 14.11% | 18.37% | 68.73 | 21.76% | 23.99 | −69.11 |
| 2005 | 33.07 | 38.30 | 15.80% | 18.99% | 70.02 | 22.34% | 24.44 | −70.40 |
| 2006 | 35.62 | 40.85 | 14.67% | 19.87% | 71.45 | 23.01% | 24.94 | −71.83 |
| 2007 | 39.66 | 45.32 | 14.28% | 21.05% | 73.98 | 23.98% | 25.82 | −74.37 |
| 2008 | 44.67 | 50.45 | 12.94% | 22.45% | 76.92 | 25.24% | 26.85 | −77.32 |
| 2009 | 50.19 | 56.42 | 12.41% | 22.53% | 80.35 | 27.18% | 28.05 | −80.79 |
| 2010 | 57.38 | 63.12 | 10.00% | 22.91% | 84.29 | 29.74% | 29.43 | −84.78 |
| 2011 | 65.78 | 72.12 | 9.64% | 23.56% | 89.74 | 32.81% | 31.33 | −90.29 |
| 2012 | 77.93 | 82.49 | 5.85% | 24.36% | 96.26 | 36.05% | 33.61 | −96.88 |
| 2013 | 90.02 | 94.11 | 4.55% | 25.47% | 103.92 | 39.77% | 36.28 | −104.61 |
| 2014 | 102.37 | 106.25 | 3.79% | 26.31% | 112.35 | 43.21% | 39.22 | −113.13 |
| 2015 | 112.51 | 118.99 | 5.76% | 26.98% | 121.76 | 47.83% | 42.51 | −122.64 |
| 2016 | 120.84 | 126.46 | 4.65% | 28.03% | 127.64 | 50.91% | 44.56 | −128.58 |
| 2017 | 126.12 | 131.58 | 4.33% | 28.45% | 131.82 | 53.12% | 46.02 | −132.80 |
| 2018 | 129.83 | 134.14 | 3.32% | 28.87% | 133.97 | 54.23% | 46.77 | −134.97 |
| 2019 | 128.05 | 133.06 | 3.92% | 27.93% | 133.02 | 53.72% | 46.44 | −134.03 |
| 2020 | 126.23 | 131.73 | 4.35% | 27.17% | 131.87 | 52.97% | 46.03 | −132.88 |
| 2021 | 123.31 | 129.80 | 5.26% | 25.67% | 130.21 | 51.86% | 45.45 | −131.23 |
| 2022 | 119.17 | 126.57 | 6.21% | 23.81% | 127.52 | 50.24% | 44.50 | −128.54 |

It can be seen from FIG. 5 and Table 8, the first prediction values are in good agreement with the actual values, with a small error, and with an average relative error of only 8.20%, which can meet needs of general work.

In order to further reduce the error between the prediction values and the actual values, in the embodiment, a quadratic fitting is performed on the first prediction values of the first formula based on the first formula to obtain a new formula (i.e., a second formula), and the error can be further reduced on the basis of the first formula. A calculation of the quadratic fitting is as follows.

A correlation diagram between the actual value Q and the first prediction value Q₁ shown in FIG. 6 is obtained based on the actual value Q and the first prediction value Q₁. As shown in FIG. 6, there is an obvious linear relationship between the actual value Q and the first prediction value Q₁.

Let a fitting curve be y=d₁+e₁x, where x represents the first prediction value Q₁, y represents a second prediction value Q₂ (i.e., target prediction value). Thus obtaining d₁=−4.2387, and e₁=0.9977 through the formulas (10) and (11), that is, y=0.9977x−4.2387; and the e₁ and d₁ are substituted into the formula (13) to obtain the second formula (i.e., the target prediction model for the formation water yield of the carbonate gas reservoir) as follows:

$${Q}_{2} = {Ah}_{0} ( - 4.168 E - 12 {F}_{1}^{2} - 2.5127 E - 5 {F}_{2} ) - 116.9277 \qquad ( 21 )$$

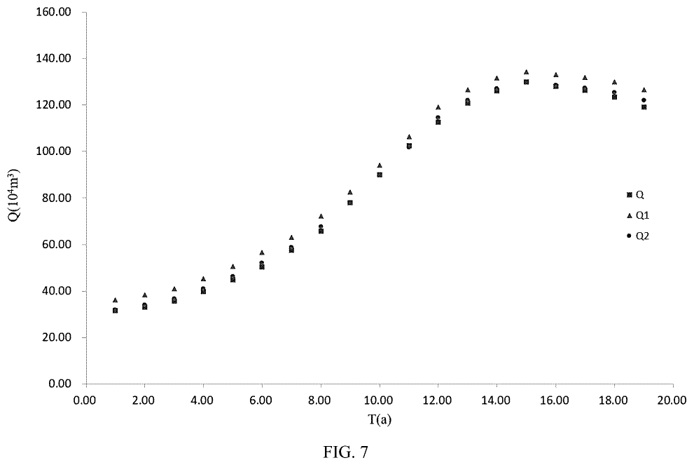

The A, h₀, F₁ and F₂ obtained in the above steps are substituted into the formula (21) to obtain second prediction values (i.e., target prediction values) of the formation water yield of the carbonate gas reservoir as shown in FIG. 7 and Table 9.

TABLE 9
The actual values, the first and second prediction values, and
relative errors of the first and second prediction values of
the formation water yield of the carbonate gas reservoir

| Actual value | First prediction | Relative error of | Second prediction | Relative error |
|---|---|---|---|---|
| Q (10⁴ m³) | value Q₁ (10⁴ m³) | Q₁ | value Q₂ (10⁴ m³) | Q₂ |
| 31.52 | 35.97 | 14.11% | 31.65 | 0.40% |
| 33.07 | 38.30 | 15.80% | 33.97 | 2.72% |
| 35.62 | 40.85 | 14.67% | 36.51 | 2.51% |
| 39.66 | 45.32 | 14.28% | 40.98 | 3.33% |
| 44.67 | 50.45 | 12.94% | 46.09 | 3.19% |
| 50.19 | 56.42 | 12.41% | 52.05 | 3.71% |
| 57.38 | 63.12 | 10.00% | 58.74 | 2.36% |
| 65.78 | 72.12 | 9.64% | 67.71 | 2.94% |
| 77.93 | 82.49 | 5.85% | 78.06 | 0.16% |
| 90.02 | 94.11 | 4.55% | 89.66 | 0.40% |
| 102.37 | 106.25 | 3.79% | 101.77 | 0.59% |
| 112.51 | 118.99 | 5.76% | 114.47 | 1.75% |
| 120.84 | 126.46 | 4.65% | 121.93 | 0.90% |
| 126.12 | 131.58 | 4.33% | 127.04 | 0.73% |
| 129.83 | 134.14 | 3.32% | 129.59 | 0.18% |
| 128.05 | 133.06 | 3.92% | 128.52 | 0.37% |
| 126.23 | 131.73 | 4.35% | 127.18 | 0.76% |
| 123.31 | 129.80 | 5.26% | 125.26 | 1.58% |
| 119.17 | 126.57 | 6.21% | 122.04 | 2.41% |

As shown in FIG. 7 and Table 9, errors between the second prediction values and the actual values obtained by the quadratic fitting are smaller.

In step (6), the initial prediction model before performing the dimension reduction process is adopted to predict the formation water yield of the carbonate gas reservoir.

The initial prediction model shown in the formula (7) is adopted to predict the formation water yield of the carbonate gas reservoir, and prediction results are shown in Table 10.

TABLE 10
Comparison of errors between prediction models before
and after performing the dimension reduction process

| | First | | Second | | Initial | |
|---|---|---|---|---|---|---|
| Actual | prediction | | prediction | | prediction | |
| value Q | value Q₁ | Relative | value | Relative | value Q₀ | Relative |
| (10⁴ m³) | (10⁴ m³) | error of Q₁ | Q₂ (10⁴ m³) | error of Q₂ | (10⁴ m³) | error of Q₀ |
| 31.52 | 35.97 | 14.11% | 31.65 | 0.40% | 38.77 | 22.99% |
| 33.07 | 38.3 | 15.80% | 33.97 | 2.72% | 41.14 | 24.41% |
| 35.62 | 40.85 | 14.67% | 36.51 | 2.51% | 44.34 | 24.48% |
| 39.66 | 45.32 | 14.28% | 40.98 | 3.33% | 48.95 | 23.43% |
| 44.67 | 50.45 | 12.94% | 46.09 | 3.19% | 54.95 | 23.02% |
| 50.19 | 56.42 | 12.41% | 52.05 | 3.71% | 59.39 | 18.32% |
| 57.38 | 63.12 | 10.00% | 58.74 | 2.36% | 66.08 | 15.16% |
| 65.78 | 72.12 | 9.64% | 67.71 | 2.94% | 74.97 | 13.96% |
| 77.93 | 82.49 | 5.85% | 78.06 | 0.16% | 85.17 | 9.28% |
| 90.02 | 94.11 | 4.55% | 89.66 | 0.40% | 98.24 | 9.13% |
| 102.37 | 106.25 | 3.79% | 101.77 | 0.59% | 110.25 | 7.70% |
| 112.51 | 118.99 | 5.76% | 114.47 | 1.75% | 125.15 | 11.23% |
| 120.84 | 126.46 | 4.65% | 121.93 | 0.90% | 138.39 | 14.52% |
| 126.12 | 131.58 | 4.33% | 127.04 | 0.73% | 146.56 | 16.21% |
| 129.83 | 134.14 | 3.32% | 129.59 | 0.18% | 151.83 | 16.95% |
| 128.05 | 133.06 | 3.92% | 128.52 | 0.37% | 145.51 | 13.63% |
| 126.23 | 131.73 | 4.35% | 127.18 | 0.76% | 139.57 | 10.57% |
| 123.31 | 129.8 | 5.26% | 125.26 | 1.58% | 129.1 | 4.70% |
| 119.17 | 126.57 | 6.21% | 122.04 | 2.41% | 116.01 | 2.65% |

As shown in Table 10, the errors of the two prediction models after performing the dimension reduction process are smaller than the errors of the initial prediction model before performing the dimension reduction process, and the predictive accuracy of the two prediction models is higher.

In step (7), formation water yield of the carbonate gas reservoir form 2023-2027 are predicted.

The formation water yield of the carbonate gas reservoir form 2023-2027 are predicted according to the prediction models shown in the formulas (20) and (21), and prediction results are shown in Table 11.

TABLE 11
Prediction values of the formation water yield
of the carbonate gas reservoir form 2023-2027

| Year | Q₁ | Q₂ | F₁ | F₂ |
|---|---|---|---|---|
| 2023 | 122.66 | 118.14 | 43.38 | −125.36 |
| 2024 | 117.49 | 112.98 | 41.99 | −121.33 |
| 2025 | 111.72 | 107.23 | 40.48 | −116.97 |
| 2026 | 106.56 | 102.07 | 39.15 | −113.15 |
| 2027 | 99.61 | 95.14 | 37.43 | −108.20 |

Probability solutions of the formation water yield of the carbonate gas reservoir in each year are further obtained according to the probability distribution of the random variable parameter h obtained by step (3), and the probability solutions are shown in Tables 12-16.

TABLE 12
Probability solutions of the formation water
yield of the carbonate gas reservoir in 2023

| Probability | Q (10⁴ m³) |
|---|---|
| 100% | 70.32 |
| 90% | 165.97 |
| 80% | 184.76 |
| 70% | 197.43 |
| 60% | 209.26 |
| 50% | 220.03 |
| 40% | 231.01 |
| 30% | 242.41 |
| 20% | 256.34 |
| 10% | 274.08 |
| 0% | 378.82 |

TABLE 13
Probability solutions of the formation water
yield of the carbonate gas reservoir in 2024

| Probability | Q (10⁴ m³) |
|---|---|
| 100% | 67.24 |
| 90% | 158.72 |
| 80% | 176.69 |
| 70% | 188.81 |
| 60% | 200.12 |
| 50% | 210.42 |
| 40% | 220.92 |
| 30% | 231.82 |
| 20% | 245.15 |
| 10% | 262.11 |
| 0% | 362.27 |

TABLE 14
Probability solutions of the formation water
yield of the carbonate gas reservoir in 2025

| Probability | Q (10⁴ m³) |
|---|---|
| 100% | 63.82 |
| 90% | 150.64 |
| 80% | 167.69 |
| 70% | 179.19 |
| 60% | 189.93 |
| 50% | 199.70 |
| 40% | 209.67 |
| 30% | 220.01 |
| 20% | 232.66 |
| 10% | 248.76 |
| 0% | 343.82 |

TABLE 15
Probability solutions of the formation water
yield of the carbonate gas reservoir in 2026

| Probability | Q (10⁴ m³) |
|---|---|
| 100% | 60.75 |
| 90% | 143.39 |
| 80% | 159.63 |
| 70% | 170.58 |
| 60% | 180.79 |
| 50% | 190.10 |
| 40% | 199.58 |
| 30% | 209.43 |
| 20% | 221.48 |
| 10% | 236.80 |
| 0% | 327.29 |

TABLE 16
Probability solutions of the formation water
yield of the carbonate gas reservoir in 2027

| Probability | Q (10⁴ m³) |
|---|---|
| 100% | 56.63 |
| 90% | 133.66 |
| 80% | 148.79 |
| 70% | 159.00 |
| 60% | 168.52 |
| 50% | 177.19 |
| 40% | 186.04 |
| 30% | 195.22 |
| 20% | 206.44 |
| 10% | 220.73 |
| 0% | 305.07 |

As shown in Tables 11-16, the prediction values obtained by the prediction model of the disclosure are all between 90% to 100% of the probability solution, and the predictive result is more accurate.

In summary, in the disclosure, the probability solutions of the prediction values of the formation water yield of the carbonate gas reservoir are obtained by performing the random sampling on the constructed mathematical distribution model of the parameters, and geological risks of the parameters and uncertainty factors brought by data abundance are considered, so as to make the results more accurate; the parameters required in the disclosure is reduced by performing the dimension reduction process, only a few parameters are required to contain the information of previous multi-parameters, and it has higher accuracy than the original prediction model. Compared to the related art, the disclosure has significant progress.

The above is merely the embodiments of the disclosure and does not impose any formal limitations on the disclosure, although the disclosure has been disclosed in the embodiments, it is not intended to limit the disclosure, any those skilled in the art can make some changes or modify equivalent embodiments using the disclosed technical content within a scope of the technical solution of the disclosure, any simple modifications, equivalent changes, or decoration s made to the above embodiments based on technical essence of the disclosure, which are not separated from the technical solution of the disclosure, shall still fall within the scope of the technical solution of the disclosure.

1. A prediction method for formation water yield of carbonate gas reservoir, comprising:
S1, constructing an initial prediction model for a formation water yield of a carbonate gas reservoir; wherein the initial prediction model is expressed as follows:
$${Q}_{0} = 0.01 Ah φ {S}_{w} / {B}_{w} \qquad ( 7 )$$
wherein Q₀ represents an initial prediction value of the formation water yield of the carbonate gas reservoir with a unit of 10⁴ cubic meters (m³); A represents a distribution area of formation water with a unit of square kilometer (km²); h represents an average thickness of the carbonate gas reservoir with a unit of meter (m); φ represents a porosity with a unit of percent (%); S_{w} represents a water saturation with a unit of %; and B_{w} represents a volume coefficient of formation water with dimensionless;
S2, collecting raw data, and pre-processing the raw data to obtain pre-processed raw data; wherein the raw data are raw data of parameters of the initial prediction model, and the raw data further comprises raw data of a permeability when the initial prediction model does not involve the permeability;
S3, performing, according to the pre-processed raw data, an uncertainty analysis and a dimension reduction process on the parameters of the initial prediction model to obtain a result of uncertainty analysis and a result of dimension reduction process; wherein the dimension reduction process is performed on the parameters of the initial prediction model to obtain a first reduced dimensionality parameter and a second reduced dimensionality parameter, the first reduced dimensionality parameter and the second reduced dimensionality parameter are respectively represented as F₁ and F₂, and F₁ is a reduced dimensionality parameter with a highest proportion of eigenvalues in total eigenvalues;
S4, constructing a target prediction model for the formation water yield of the carbonate gas reservoir according to the result of dimension reduction process; wherein step S4 comprises:
S41, fitting a parameter Ah₀F₁ with an actual value of the formation water yield of the carbonate gas reservoir to obtain first fitting coefficients; wherein a mathematical formula (8) for fitting is expressed as follows:
$$Q = {aAh}_{0} {F}_{1}^{2} + {bAh}_{0} {F}_{1} + c \qquad ( 8 )$$
wherein Q represents the actual value of the formation water yield of the carbonate gas reservoir with a unit of 10⁴ m³; a, b, and c represent the first fitting coefficients; and h₀ represents an average sampling thickness of the carbonate gas reservoir with a unit of m;
S42, fitting F₁ with F₂ to obtain second fitting coefficients; wherein mathematical formulas (9)-(11) for fitting are expressed as follows:
$$y = d + ex \qquad ( 9 )$$
$$d = \overline{y} - e \overline{x} \qquad ( 10 )$$
$$e = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 11 )$$
wherein e and d represent the second fitting coefficients; xᵢ represents an i-th independent variable parameter; x̅ represents an average value of independent variable parameters; yᵢ represents an i-th dependent variable parameter; y̅ represents an average value of dependent variable parameters; and n represents a total number of the raw data of the random variable parameter; and
S43, substituting the first fitting coefficients obtained in step S41 and the second fitting coefficients obtained in step S42 into the mathematical formula (8), to obtain a first prediction model for the formation water yield of the carbonate gas reservoir by a formula (12) as follows:
$${Q}_{1} = {Ah}_{0} ( {aF}_{1}^{2} + {beF}_{2} ) + c + bd \qquad ( 12 )$$
wherein Q₁ represents a first prediction value of the formation water yield of the carbonate gas reservoir with a unit of 10⁴ m³; and
S5, obtaining, according to the target prediction model for the formation water yield of the carbonate reservoir, a predictive probability solution of the formation water yield of the carbonate gas reservoir by combining the result of uncertainty analysis;
wherein the prediction method for formation water yield of carbonate gas reservoir further comprises: applying the predictive probability solution in formulating countermeasures of developing the carbonate gas reservoir, and guiding an oil and gas field company in an extraction of the carbonate gas reservoir.

2. The prediction method for formation water yield of carbonate gas reservoir as claimed in claim 1, where in step S3, the performing an uncertainty analysis on the parameters of the initial prediction model comprises:
S31, selecting a random variable parameter of the parameters of the initial prediction model to perform the uncertainty analysis on the random variable parameter;
S32, constructing a mathematical distribution model for the random variable parameters; wherein the mathematical distribution model is expressed as follows:
$$P ( v ) = ( \frac{1}{\sqrt{2 π {σ}^{2}}} ) {e}^{- \frac{{( v - μ )}^{2}}{2 {σ}^{2}}} , \qquad ( 1 )$$
$$- ∞ < v < ∞$$
$$σ = \sqrt{( \sum {v}_{i} - μ ) / n} \qquad ( 2 )$$
$$μ = \sum {v}_{i} / n \qquad ( 3 )$$
wherein P(v) represents a distribution function; o represents a standard deviation; v represents a value of the random variable parameter; u represents a mathematic expectation; vᵢ represents an i-th value of the random variable parameter; and n represents a total number of raw data of the random variable parameter;
S33, performing, according to the mathematical distribution model, a random sampling on the random variable parameter to obtain sampled values, and converting the sampled values to a probability distribution of the random variable parameter through a mathematical formula; wherein the mathematical formula is expressed as follows:
$$F ( v ) = 1 - ( \frac{1}{\sqrt{2 π {σ}^{2}}} ) \int {e}^{[ - \frac{{( v - μ )}^{2}}{2 {σ}^{2}} ]} dv , \qquad ( 4 )$$
$$- ∞ < v < ∞$$
wherein F(v) represents a probability distribution function; and
S34, obtaining a probability distribution sampling value of the random variable parameter according to the probability distribution; wherein the probability distribution sampling value is the result of uncertainty analysis of the random variable parameter.

3. The prediction method for formation water yield of carbonate gas reservoir as claimed in claim 1, where in step S3, the performing a dimension reduction process on the parameters of the initial prediction model comprises:
S31′, standardizing the raw data to obtain standardized data matrix;
S32′, obtaining, according to the standardized data matrix, correlation coefficients, to thereby obtain a correlation coefficient matrix; wherein a formula for calculating each of correlation coefficients is expressed as follows:
$${R}_{ij} = \frac{{\sum }_{k = 1}^{m} ( {x}_{ik} - \overline{{x}_{i}} ) ( {x}_{jk} - \overline{{x}_{j}} )}{\sqrt{{\sum }_{k = 1}^{m} {( {x}_{ik} - \overline{{x}_{i}} )}^{2} {\sum }_{k = 1}^{m} {( {x}_{jk} - \overline{{x}_{j}} )}^{2}}} \qquad ( 5 )$$
$$( i , j = 1 , 2 , … , n ) □$$
wherein Rᵢⱼ represents the correlation coefficient; m represents a total number of rows or columns of the standardized data matrix; k represents a k-th row or a k-th column; xᵢₖ represents a parameter of an i-th row and a k-th column in the standardized data matrix; x̅ₗ represents an average value of all parameters in the i-th row of the standardized data matrix; xⱼₖ represents a parameter of a j-th column and a k-th row in the standardized data matrix; and x̅ⱼ represents an average value of all parameters in the j-th column of the standardized data matrix;
S33′, constructing an eigenmatrix |R−λE|=0; wherein R represents the correlation coefficient matrix, and E represents an identity matrix;
S34′, solving eigenvalues 1 of the eigenmatrix, and taking a sum of eigenvalues larger than a total eigenvalue threshold as reduced dimensionality eigenvalues;
S35′, constructing, according to the reduced dimensionality eigenvalues, an equation system (R−λE) X=0, and obtaining nonzero solutions of the equation system; and
S36′, taking the nonzero solutions as eigenvectors corresponding to the reduced dimensionality eigenvalues to obtain a reduced dimensionality parameter as the result of dimension reduction process.

4. The prediction method for formation water yield of carbonate gas reservoir as claimed in claim 1, where in step S2, the pre-processing the raw data further comprises: eliminating an outlier in raw data of each parameter of the parameters.

5. The prediction method for formation water yield of carbonate gas reservoir as claimed in claim 4, wherein the eliminating an outlier in the raw data of each parameter of the parameters comprises:
S21, obtaining an average value of the raw data of each parameter, and a deviation D between each raw datum of the raw data of each parameter and the average value;
S22, calculating a probability error p of each parameter according to the deviation D;
S23, constructing a D/p standard value of each parameter, and calculating a D/p value of each raw datum of the raw data of each parameter; and
S24, determining whether each raw datum of the raw data of each parameter is an outlier according to the D/p value and the D/p standard value, comprising:
in response to the D/p value of a corresponding one raw data being larger than the D/p standard value of the corresponding one raw data, determining the corresponding one raw data as an outlier, and eliminating the corresponding one raw data; in response to the D/p value of a corresponding one raw data being not larger than the D/p standard value of the corresponding one raw data, reserving the corresponding one raw data.

6. The prediction method for formation water yield of carbonate gas reservoir as claimed in claim 5, where in step S22, a formula for calculating the probability error p is expressed as follows:
$$p = 0.6745 \sqrt{\frac{{\sum }_{i = 1}^{n} {D}^{2}}{n - 1}} \qquad ( 6 )$$
wherein n represents a total number of the raw data of each parameter;
in step S23, D/p standard values corresponding to different total numbers n of raw data are respectively as follows:
when 5≤n<10 is satisfied, the D/p standard value is 2.5;
when 10≤n<15 is satisfied, the D/p standard value is 2.9;
when 15≤n<20 is satisfied, the D/p standard value is 3.2;
when 20≤n<50 is satisfied, the D/p standard value is 3.3;
when 50≤n<100 is satisfied, the D/p standard value is 3.8; or
when n≥100 is satisfied, the D/p standard value is 4.2.

7. (canceled)

8. The prediction method for formation water yield of carbonate gas reservoir as claimed in claim 1, where in step S2, the raw data comprise a thickness of the carbonate gas reservoir, the porosity, the permeability and the water saturation.

9. (canceled)

10. The prediction method for formation water yield of carbonate gas reservoir as claimed in claim 1, where in step S4, the constructing a target prediction model for the formation water yield of the carbonate gas reservoir further comprises:
S44, fitting, through the mathematical formula (9), the first prediction value of the formation water yield of the carbonate gas reservoir obtained by the mathematical formula (12) with the actual value of the formation water yield of the carbonate gas reservoir to obtain third fitting coefficients;
S45, substituting the third fitting coefficients into the mathematical formula (8) to obtain the target prediction model for the formation water yield of the carbonate gas reservoir as follows:
$${Q}_{2} = {e}_{1} {Ah}_{0} ( {aF}_{1}^{2} + {beF}_{2} ) + {e}_{1} c + {e}_{1} bd + {d}_{1} \qquad ( 13 )$$
wherein Q₂ represents a target prediction value of the formation water yield of the carbonate gas reservoir with a unit of 10⁴ m³; and e₁ and d₁ represent the third fitting coefficients.

11. A prediction method for formation water yield of carbonate gas reservoir, comprising:
S1, constructing an initial prediction model for a formation water yield of a carbonate gas reservoir; wherein the initial prediction model is expressed as follows:
$${Q}_{0} = 0.01 Ah φ {S}_{w} / {B}_{w} \qquad ( 7 )$$
wherein Q₀ represents an initial prediction value of the formation water yield of the carbonate gas reservoir with a unit of 10⁴ cubic meters (m³); A represents a distribution area of formation water with a unit of square kilometer (km²); h represents an average thickness of the carbonate gas reservoir with a unit of meter (m); φ represents a porosity with a unit of percent (%); S_{w} represents a water saturation with a unit of %; and B_{w} represents a volume coefficient of formation water with dimensionless;
S2, collecting raw data, and pre-processing the raw data to obtain pre-processed raw data; wherein the raw data are raw data of parameters of the initial prediction model, and the raw data further comprises raw data of a permeability when the initial prediction model does not involve the permeability;
S3, performing, according to the pre-processed raw data, an uncertainty analysis and a dimension reduction process on the parameters of the initial prediction model to obtain a result of uncertainty analysis and a result of dimension reduction process; wherein the dimension reduction process is performed on the parameters of the initial prediction model to obtain a first reduced dimensionality parameter and a second reduced dimensionality parameter, the first reduced dimensionality parameter and the second reduced dimensionality parameter are respectively represented as F₁ and F₂, and F₁ is a reduced dimensionality parameter with a highest proportion of eigenvalues in total eigenvalues;
S4, constructing a target prediction model for the formation water yield of the carbonate gas reservoir according to the result of dimension reduction process; wherein step S4 comprises:
S41, fitting a parameter Ah₀F₁ with an actual value of the formation water yield of the carbonate gas reservoir to obtain first fitting coefficients; wherein a mathematical formula (8) for fitting is expressed as follows:
$$Q = {aAh}_{0} {F}_{1}^{2} + {bAh}_{0} {F}_{1} + c \qquad ( 8 )$$
wherein Q represents the actual value of the formation water yield of the carbonate gas reservoir with a unit of 10⁴ m³; a, b, and c represent the first fitting coefficients; and h₀ represents an average sampling thickness of the carbonate gas reservoir with a unit of m;
S42, fitting F₁ with F₂ to obtain second fitting coefficients; wherein mathematical formulas (9)-(11) for fitting are expressed as follows:
$$y = d + ex \qquad ( 9 )$$
$$d = \overline{y} - e \overline{x} \qquad ( 10 )$$
$$e = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 11 )$$
wherein e and d represent the second fitting coefficients; xᵢ represents an i-th independent variable parameter; x̅ represents an average value of independent variable parameters; yᵢ represents an i-th dependent variable parameter; y̅ represents an average value of dependent variable parameters; and n represents a total number of the raw data of the random variable parameter; and
S43, substituting the first fitting coefficients obtained in step S41 and the second fitting coefficients obtained in step S42 into the mathematical formula (8), to obtain a first prediction model for the formation water yield of the carbonate gas reservoir by a formula (12) as follows:
$${Q}_{1} = {Ah}_{0} ( {aF}_{1}^{2} + {beF}_{2} ) + c + bd \qquad ( 12 )$$
wherein Q₁ represents a first prediction value of the formation water yield of the carbonate gas reservoir with a unit of 10⁴ m³; and
S5, obtaining, according to the target prediction model for the formation water yield of the carbonate reservoir, a predictive probability solution of the formation water yield of the carbonate gas reservoir by combining the result of uncertainty analysis, wherein the predictive probability solution consists of multiple formation water yield values and multiple probability values respectively corresponding to the multiple formation water yield values; and
S6, determining a formation water yield value with a probability value greater than a target probability value from the multiple formation water yield values, as a target formation water yield predict result; and formulating drainage countermeasures based on the target formation water yield predict result, to thereby drain water corresponding to the target formation water yield predict result from the carbonate gas reservoir based on the drainage countermeasures.
